(19) United States
(12) Patent Application Publication
(10) Pub. No.: US 2006/0115127 A1
(43) Pub. Date: Jun. 1, 2006

(54) Print inspection apparatus

(75) Inventor: Fumihiro Hatayama, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/244,032

(22) Filed: Oct. 6, 2005

(30) Foreign Application Priority Data
Nov. 29, 2004 (JP) JP2004-344398

(51) Int. Cl. G06K 9/00

(52) U.S. Cl. 382/112

(57) ABSTRACT

An inspection system incorporated in a printing apparatus provides a detailed inspection in which an amount of data taken as an object of inspection in unit region of printing paper is relatively large, and a simple inspection in which the amount of the data is relatively small. A region of printing paper, which becomes an object of processing when a mode signal is “H”, is taken as an object of inspection in the detailed inspection. A region of the printing paper, which becomes an object of processing when the mode signal is “L”, is taken as an object of inspection in the simple inspection. Thereby, the entire printing paper can be inspected without any large drop in the accuracy of inspection, and the amount of data handled in the inspection can be reduced considerably.

### BACKGROUND OF THE INVENTION

1. Field of the Invention

The present invention relates to a technique of inspecting printed material printed by a printing apparatus.

2. Description of the Background Art

Heretofore, there has been proposed print inspection apparatuses for inspecting whether the necessary contents are printed precisely in printed material printed by a printing apparatus. Such a print inspection apparatus performs inspection by comparing reference data and inspected data, wherein, for example, the reference data is image data used in printing by the printing apparatus, and the inspected data is image data obtained by reading the actual contents of the printed material through a light receiving sensor etc. (disclosed, for example, in Japanese Patent Publication Laid-Open No. 10-318731).

In cases where a plurality of pages are continuously printed, it is desirable to obtain its print inspection result in approximately real time. Therefore such extremely high-speed operation performance that permits approximately real time processing of image data having vast amounts of data is demanded in a print inspection apparatus. This high-speed operation performance is a factor of cost increase in the print inspection apparatus.

To reduce the amount of data handled by the print inspection apparatus with the purpose of cost reduction, it can be considered, for example, to lower the resolution of image data to be compared in inspection, or take only part of printed material as an object of inspection.

However, when the resolution of the compared image data is lowered, a defect of minor level might not be detected over a long period of time. When only part of printed material is taken as an object of inspection, it is impossible to detect a defect at the rest of the printed material. Hence in both cases, the accuracy of inspection drops considerably.

Further, when inspecting the results of variable printing (a technique of printing contents specific to each of a plurality of pages), it is especially desirable to inspect the entire printed material because the print contents will vary over different pages.

### SUMMARY OF THE INVENTION

The present invention is directed to a print inspection apparatus that inspects printed material produced by a printing apparatus.

This print inspection apparatus comprises: a reference generating part for generating reference data on the basis of print data that the printing apparatus uses for printing; a capturing part for capturing inspected data from the printed material; and an inspecting part for inspecting the printed material by comparing the reference data and the inspected data in unit region of the printed material. The inspecting part provides a detailed inspection in which an amount of data taken as an object of comparison in the unit region is relatively large, and a simple inspection in which the amount of the data is relatively small. A partial region of the printed material is taken as an object of inspection in the detailed inspection. At least part of the region except for the partial region of the printed material is taken as an object of inspection in the simple inspection.

The detailed inspection is performed for a partial region of printed material, and the simple inspection is performed for the rest. This permits substantial reductions in the amount of data handled in the inspection, while inspecting the entire printed material without seriously lowering the accuracy of inspection.

In accordance with one aspect of the invention, the printed material contains a plurality of pages, and contents of the printed material include a variable portion specific to each of the plurality of pages.

The amount of data handled in inspection can be reduced considerably, while inspecting all of pages that have different contents of printed material.

In accordance with another aspect of the invention, this print inspection apparatus further comprises a storing part for storing fixed portion data indicating a fixed portion except for the variable portion in the contents of the printed material. The reference regenerating part inputs variable portion data that the printing apparatus uses to print the variable portion, and generates the reference data on the basis of the variable portion data and the fixed portion data.

The amount of data inputted for generating reference data can be reduced.

The present invention is also directed to a printing apparatus capable of inspecting printed material.

The present invention is also directed to a print inspection method for inspecting printed material of a printing apparatus.

Accordingly, the present invention has its object to provide a technique of permitting substantial reductions in the amount of data handled in inspection, while inspecting the overall printed material without seriously lowering the accuracy of inspection.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic construction of a printing apparatus;

FIG. 2 is a diagram showing one example of before-print printing paper;

FIG. 3 is a diagram showing one example of after-print printing paper in a first preferred embodiment;

FIG. 4 is a diagram showing an outline of operation in a printing apparatus;

FIG. 5 is a diagram showing details of a function related to print inspection processing in the first preferred embodiment;

FIG. 6 is a diagram showing details of processing in the print inspection processing in the first preferred embodiment;

FIG. 7 is a diagram showing a detailed flow of a simple inspection processing in the first preferred embodiment;

FIG. 8 is a diagram showing a detailed flow of a detailed inspection processing in the first preferred embodiment;

FIG. 9 is a diagram showing the relationship between a mode signal and inspection in an inspection system;

FIGS. 10 and 11 are diagrams showing examples of regions that become an object of inspection in the detailed inspection;

FIGS. 12 and 13 are diagrams showing examples of paper blocks removed from a printing apparatus;

FIG. 14 is a diagram showing one example of regions that become an object of inspection in the detailed inspection;

FIG. 15 is a diagram showing one example of after-print printing paper in a second preferred embodiment;

FIG. 16 is a diagram showing details of a function related to print inspection processing in the second preferred embodiment;

FIG. 17 is a diagram showing details of the print inspection processing in the second preferred embodiment;.

FIG. 18 is a diagram showing a detailed flow of a simple inspection processing in the second preferred embodiment;

FIG. 19 is a diagram showing a detailed flow of a detailed inspection processing in the second preferred embodiment;

FIG. 20 is a diagram showing an example of regions that become an object of inspection;

FIG. 21 is a diagram showing one example of regions that become an object of inspection in the detailed inspection; and

FIGS. 22 and 23 are diagrams showing the relationship between a mode signal, printing in a printing system, and inspection in an inspection system.

### DESCRIPTION OF THE PREFERRED EMBODIMENTS

Preferred embodiments of the present invention will next be described with reference to the accompanying drawings. The following is a specific example where the function as a print inspection apparatus according to a preferred embodiment is incorporated in the inside of a printing apparatus.

### 1. First Preferred Embodiment

<1-1. Outline>

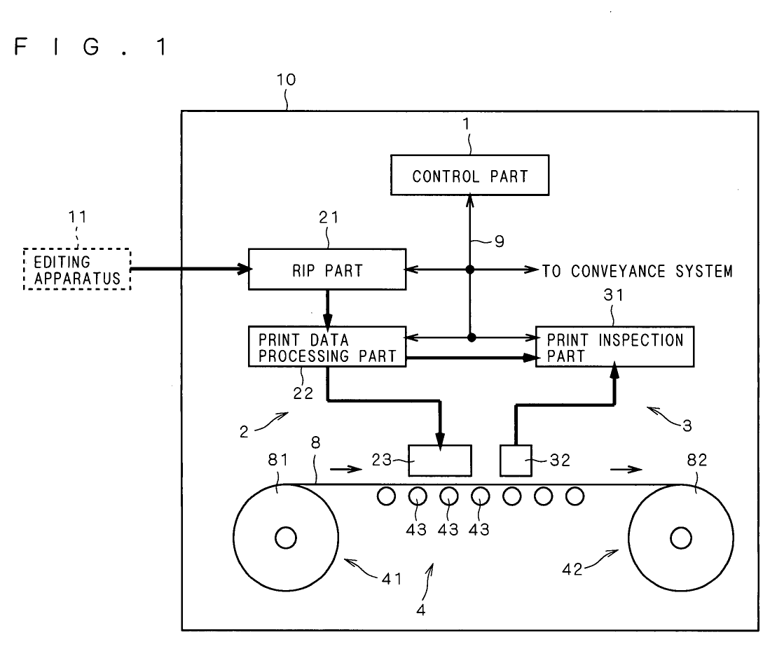

FIG. 1 is a diagram showing a schematic construction of a printing apparatus according to a first preferred embodiment. A printing apparatus 10 is constructed as an ink jet printer, which performs printing to printing paper 8 in an ink jet system (in which ink is atomized and sprayed onto printing paper), based on print data inputted from an external editing apparatus 11.

The printing apparatus 10 is provided with a control part 1 for controlling the entire apparatus, and a processing system to be controlled by the control part 1. The control part 1 has a microcomputer composed of such as CPU, RAM, and ROM. A variety of control functions under the control part 1 are executable by the CPU performing operation processing, while utilizing the RAM according to a predetermined program and data.

The processing system of the printing apparatus 10 can be roughly divided into a printing system 2 that performs printing by using print data; a conveyance system 4 that conveys the printing paper 8 taken as an object of printing; and an inspection system 3 that inspects the after-print printing paper 8 as printed material.

The printing system 2 is provided with a RIP part 21 and a print data processing part 22 that process print data as image data used in printing; and a print head 23 that performs printing to the printing paper 8 on the basis of the processed print data.

Print data (source data) inputted from the editing apparatus 11 is rasterized by the RIP part 21, and converted to print data (raster data) in raster format. The raster data obtained by the RIP part 21 is further converted by the print data processing part 22 to print data (head data) that the print head 23 is able to print. Based on this head data, the print head 23 performs printing on the printing paper 8. The print head 23 is provided with a plurality of nozzles, through which printing of ink jet system is done. The nozzles are arranged in one dimension in a main scanning direction (a direction orthogonal to the conveyance direction of the printing paper 8, that is, a vertical scanning direction, on a horizontal surface) on the opposite side of an upper surface of the printing paper 8 (a surface taken as an object of printing).

The conveyance system 4 is provided with a first holding part 41 for before-print printing paper 81, and a second holding part 42 for holding after-print printing paper 82, and it conveys the printing paper 8 from the first holding part 41 to the second holding part 42 by motors (not shown) disposed at the first and second holding parts 41 and 42. A paper block, as a whole of the printing paper 8 handled by the printing apparatus 10 of this preferred embodiment, is shaped in such a paper roll that a lengthy paper is wound into rolls. The printing paper 8 can be held in a state of being wound into rolls at both of the first and second holding parts 41 and 42.

The conveyance system 4 is further provided with a plurality of rollers 43 that define a conveyance path of the printing paper 8 from the first holding part 41 to the second holding part 42. The printing paper 8 is conveyed while being guided by these rollers 43, so that it moves to the right hand when viewed in the figure (the vertical scanning direction) in a horizontal direction immediately below the print head 23. The print head 23 performs printing to the printing paper 8 that is so passed immediately therebelow.

The inspection system 3 is provided with an image pickup sensor 32 that captures image data by reading the contents of the printing paper 8 after being subjected to printing, and a print inspection part 31 that performs inspection on the basis of the image data obtained by the image pickup sensor 32.

The image pickup sensor 32 is constructed as a line sensor composed of a plurality of light receiving pixels arranged in one dimension, and disposed at an upper part on the downstream side from the print head 23 on the conveyance path of the printing paper 8. The plurality of light receiving pixels of the image pickup sensor 32 are opposed to the upper surface of the printing paper 8 and arranged along the main scanning direction. As these light receiving pixels scan the printing paper 8 passing immediately therebelow, the contents of the printing paper 8 printed by the print head 23 can be captured as image data. In the alternative, the image pickup sensor 32 may be constructed as a two-dimensional sensor, in which a plurality of light receiving pixels are arranged in two dimension.

The print inspection part 31 inspects whether the contents to be printed on the printing paper 8 is printed precisely by employing, as inspected data, the image data captured by the image pickup sensor 32, and comparing the inspected data with reference data containing the contents to be printed. The print inspection part 31 will be described hereinafter in detail.

The foregoing control part 1, printing system 2, conveyance system 4, and inspection system 3 are connected to each other via a bus line 9. This enables to send and receive various data and signals between the control part 1, printing system 2, conveyance system 4, and inspection system 3.

<1-2. Variable Printing>

The printing apparatus 10 having the above-mentioned construction is capable of performing variable printing to print contents specific to a plurality of pages, respectively. The following is the outline of variable printing done by the printing apparatus 10.

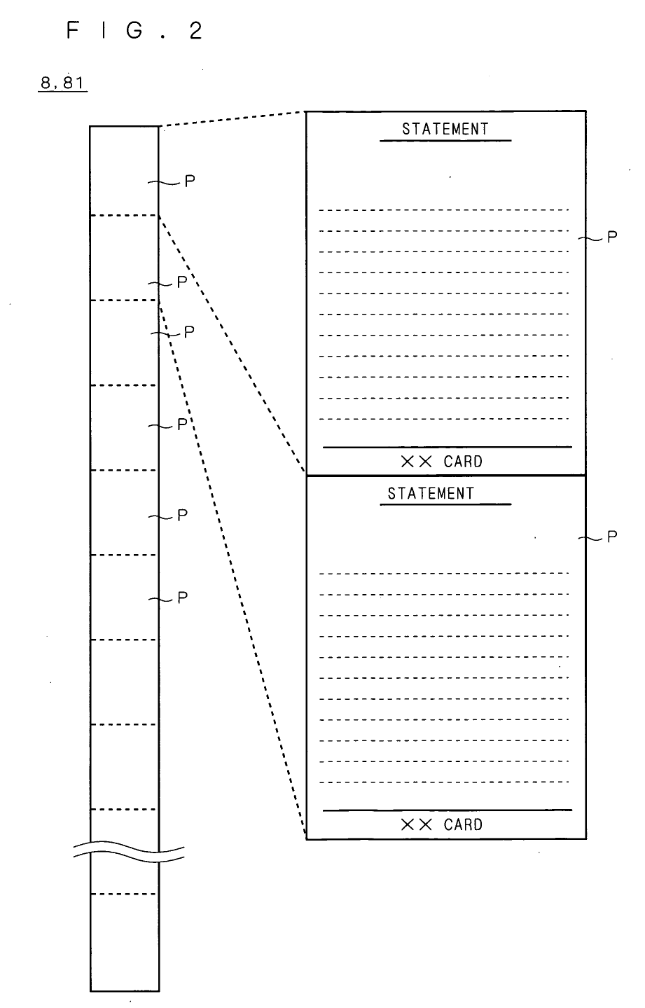

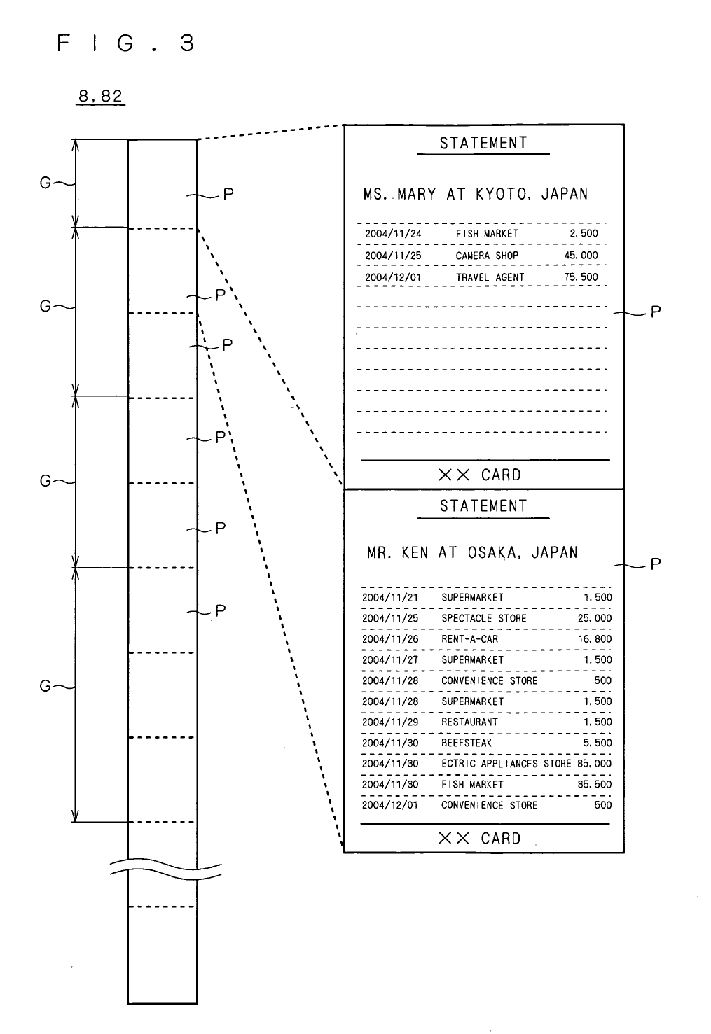

FIGS. 2 and 3 are diagrams showing one example of the printing paper 8 to be handled by the printing apparatus 10. Specifically, FIG. 2 shows a state of before-print printing paper 81; and FIG. 3 shows a state of after-print printing paper 82. In these figures, one for use in a statement for credit cards etc. is illustrated as the printing paper 8. The printing paper 8 that can be handled by the printing apparatus 10 should not be limited to this. In the following specific example, however, suppose that the printing apparatus 10 performs printing related to such a statement.

As shown in these figures, the printing paper 8 formed as a paper roll is in a lengthy shape, and contains a plurality of pages P in a state of being connected in series. As shown in FIG. 2, a predetermined format is previously printed (pre-printed) on each page P of the before-print printing paper 81. These pre-printing contents are common to the plurality of pages P.

The printing apparatus 10 further performs additional printing to each page of the printing paper 81 so pre-printed, thereby producing the printing paper 82 as shown in FIG. 3. Such additional printing is defined as variable printing, and the contents to be printed are specific to the plurality of pages, respectively. Accordingly in the after-print printing paper 82, the plurality of pages P have different contents, as shown in FIG. 3.

In the contents of the after-print printing paper 82, a portion common among a plurality of pages (a portion related to pre-printing) is hereinafter referred to a “fixed portion,” and a portion specific to each of the plurality of pages (a portion related to variable printing) is referred to as a “variable portion.”

Since the printing apparatus 10 of this preferred embodiment performs printing related to a statement, a statement with respect to a customer may be printed on one page or a plurality of continuous pages. In this preferred embodiment, such a continuous page group (one page or continuous two or more pages) related to one customer is referred to as a “group” G. Accordingly the after-print printing paper 82 can be divided into a plurality of groups G, each of which is composed of a continuous page group.

<1-3. Operational Outline>

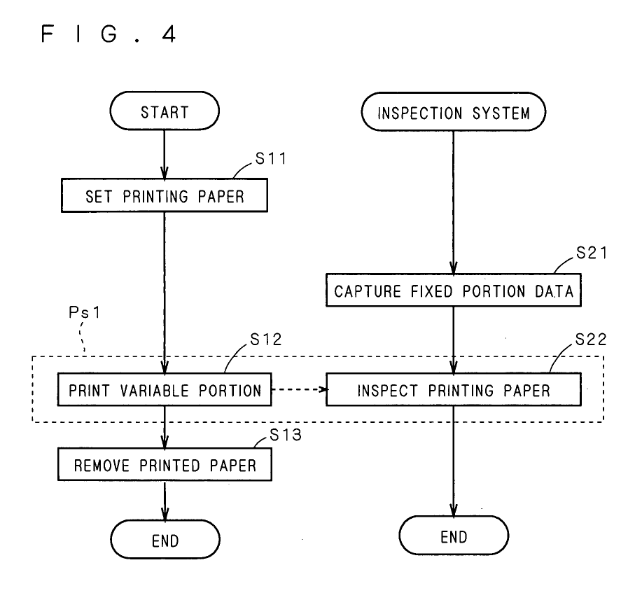

The operational outline of the printing apparatus 10 will next be described. FIG. 4 is a diagram showing an operational outline of the printing apparatus 10.

Referring to the flow on the left side of FIG. 4, in the printing apparatus 10, the printing paper 81 previously containing a fixed portion is first held at the first holding part 41, and set in such a state as to be conveyable to the second holding part 42 (step S11). While conveying the printing paper 8 by the conveyance system 4, the printing system 2 performs print processing for printing the variable portion to each page of the printing paper 8 (step S12). At the completion of printing to all pages, it is possible to obtain after-print printing paper 82 containing both of the fixed portion and the variable portion, and the after-print printing paper 82 is then removed from the second holding part 42 (step S13). Such a series of processing is to be done for each block of paper as a whole of one printing paper 8 (a roll of paper).

In this series of processing, during the time that the printing system 2 performs print processing (step S12), in parallel to that, the inspection system 3 performs inspection processing for inspecting the after-print printing paper 82 (step S22), as shown in the flow on the right side in the figure. The print processing (step S12) and the inspection procession (step S22) so done in parallel are hereinafter referred to generally as “print inspection processing” Ps1.

Meanwhile the printing apparatus 10 of this preferred embodiment has two inspecting modes: a detailed inspecting mode to inspect the printing paper 8 at relatively high accuracy; and a simple inspecting mode to inspect it at relatively low accuracy. These two inspecting modes can be changed according to a mode signal outputted from the RIP part 21. Although the explanation below will proceed on the assumption that a mode signal is outputted from the RIP part 21, it may be outputted from the control part 1.

In the “print inspection processing” Ps1, both of the printing system 2 and the inspection system 3 are configured so as to perform processing according to an inspecting mode executed. The following is the details of this print inspection processing Ps1.

<1-4. Functional Construction Related to Print inspection Processing>

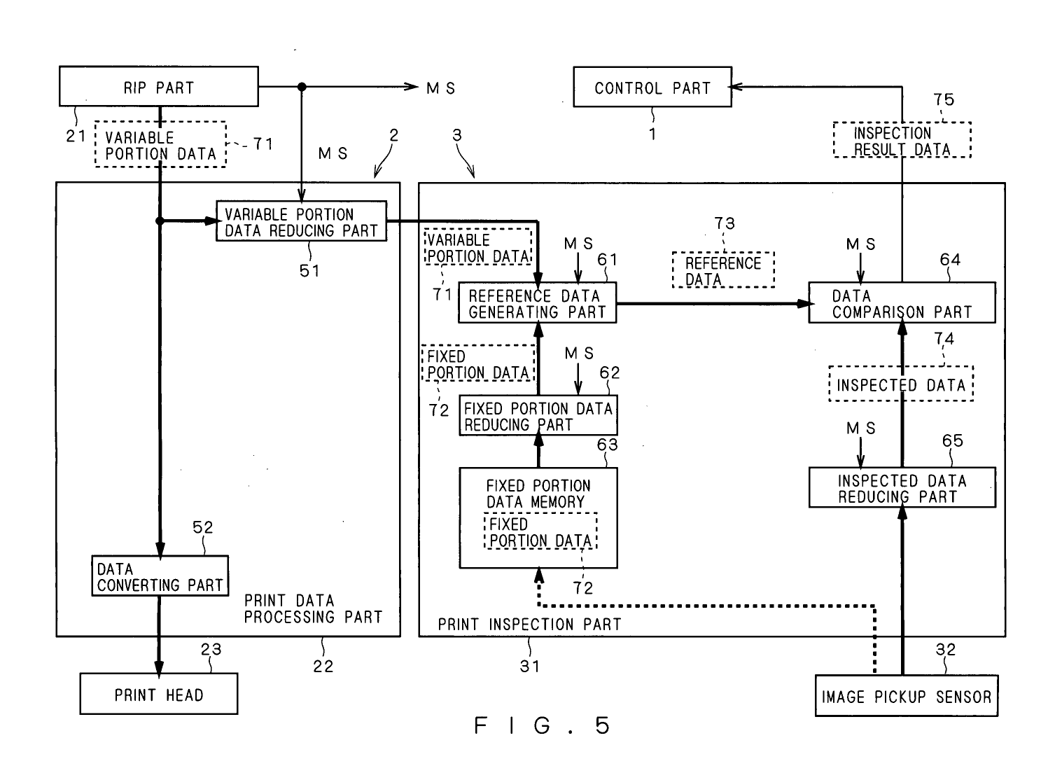

FIG. 5 is a block diagram showing the details of functions of the printing system 2 and the inspection system 3 that are related to the print inspection processing Ps1.

Referring to FIG. 5, a variable portion data reducing part 51 and a data converting part 52 indicate image processing functions effected by the print data processing part 22 in the printing system 2. A reference data generating part 61, fixed portion data reducing part 62, data comparison part 64, and inspected data reducing part 65 indicate image processing functions effected by the print inspection part 31 in the inspection system 3. A mode signal MS is inputted from the RIP part 21 to the above respective parts as the image processing function, in order to perform image processing according to the inspecting mode. Each part of these may be implemented on a hardware circuit such as a dedicated integrated circuit, or implemented in software.

A fixed portion data memory 63 is an image memory capable of storing image data, which is disposed at the print inspection part 31. The fixed portion data memory 63 stores fixed portion data 72 that is image data indicating the contents of a fixed portion of the printing paper 8. As shown in FIG. 4, the fixed portion data 72 can be captured by the image pickup sensor 32 and is previously stored before the print inspection processing Ps1, namely, before the inspection of the printing paper 8. In capturing the fixed portion data 72, a page of the before-print printing paper 8 is conveyed without printing, in order for the image pickup sensor 32 to read it.

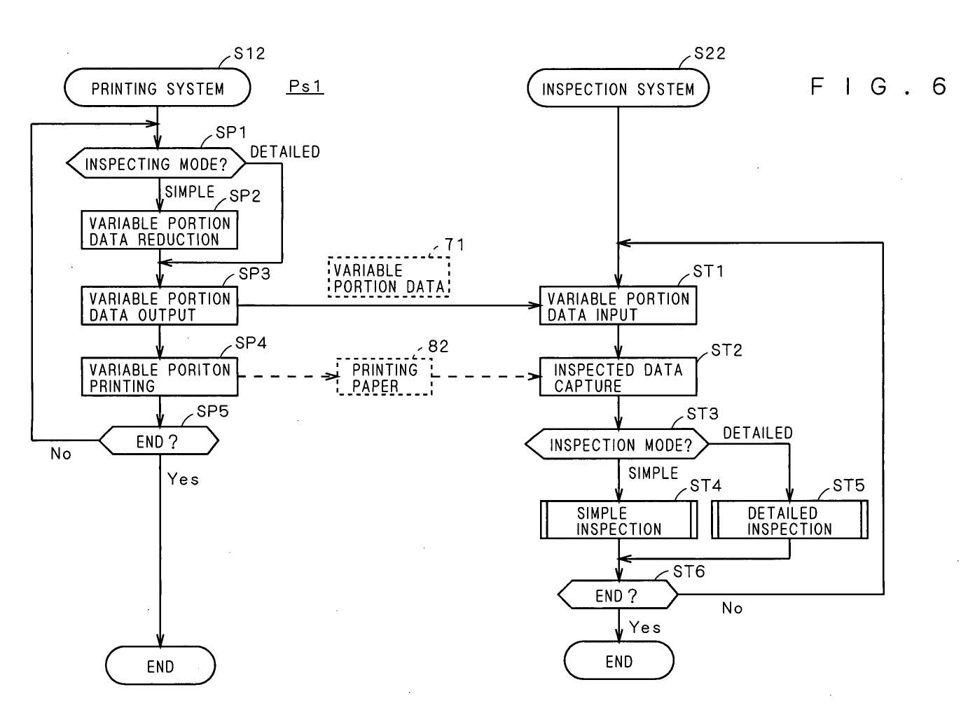

FIG. 6 is a diagram showing the details of processing in the printing system 2 and the inspection system 3 during the print inspection processing Ps1. The flow on the left side in the figure indicates a flow of print processing in the printing system 2 (step S12 in FIG. 4), and the flow on the right side indicates a flow of inspection processing in the inspection system 3 (step S22 in FIG. 4). The details of these will next be described in sequence.

<1-5. Print Processing>

Referring to the left side flows in FIGS. 5 and 6, the print processing of the printing system 2 will first be described.

The main processing of the printing system 2 is to print the printing paper 8 on the basis of the variable portion data 71 related to a variable portion (step SP4). The variable portion data 71 to be supplied as raster data from the RIP part 21 is converted to head data and supplied to the print head 23 by the data converting part 52. This causes the print head 23 to perform printing of the variable portion onto the printing paper 8. Such processing will be repeated in predetermined unit region of the printing paper 8, until the completion of the printing of all pages contained in the printing paper 8 (during “NO” in step SP5).

The term “unit region” means a region that covers the entire width of the main scanning direction in the printing paper 8, and has a predetermined width in the vertical scanning direction. This unit region is not limited to a two-dimensional region, and it may be a one-dimensional region along the main scanning direction. In this preferred embodiment, one page of the printing paper 8 can be divided into a predetermined number of unit regions. Accordingly, performing a predetermined number of printings for one unit region can complete printing related to one page of the printing paper 8.

Prior to printing to such one unit region, the variable portion data 71 for one unit region used in this printing is to be outputted from the print data processing part 22 to the print inspection part 31 (step SP3). At the time of the output of the variable portion data 71, the resolution of the variable portion data 71 is adjusted by the variable portion data reducing part 51 according to inspecting mode (steps SP1, SP2).

Specifically, the inspecting mode is determined on the basis of the mode signal MS inputted to the variable portion data reducing part 51 (step SP1). In the detailed inspecting mode, all pixels of the variable portion data 71 are directly outputted to the print inspection part 31 (step SP3). On the other hand, in the simple inspecting mode, the pixels of the variable portion data 71 are reduced at a predetermined rate by the variable portion data reducing part 51, thereby lowering the resolution (down sampling) (step SP2). As a result, the variable portion data 71 of low resolution is outputted to the print inspection part 31.

Thus, the printing system 2 repeats per unit region a sequence of processing of: the adjustment of the resolution of the variable portion data 71 according to the inspecting mode (steps SP1, SP2); the output of the variable portion data 71 to the print inspection part 31 (step SP3); and the printing based on the variable portion data 71 (step SP4).

Note that during the simple inspecting mode, the resolution of the variable portion data 71 to be outputted to the print inspection part 31 is lowered, but the resolution of the variable portion data 71 to be used in printing is not changed. Hence, the detailed inspecting mode and the simple inspecting mode are the same in printing quality itself.

<1-6. Inspection Processing>

The inspection processing of the inspection system 3 in parallel across the foregoing processing of the printing system 2 will next be described with reference to FIG. 5 and the right-hand flow in FIG. 6.

First, the variable portion data 71 related to one unit region, which has been outputted from the printing system 2, is inputted to the reference data generating part 61 (step ST1). Next, the image pickup sensor 32 scans a unit region of the printing paper 82, which has been printed in the printing system 2 by using data having the same contents as the inputted variable portion data 71. The obtained image data is then subjected to distortion correction of optical system, thereby obtaining image data indicating the contents of this unit region as the inspected data 74 (step ST2).

The unit region related to the variable portion data 71 inputted in step ST1 is identical with the unit region related to the inspected data 74 obtained in step ST2. In the inspection system 3, the inspection for this one unit region is to be repeated. Hereinafter, a unit region that becomes an object of inspection at that time is referred to as a “target unit region.”

After obtaining the variable portion data 71 related to the target unit region and the inspected data 74 related to the target unit region, the processing according to the inspecting mode based on the mode signal MS is performed. Specifically, the simple inspection processing is done in the simple inspecting mode (steps ST3, ST4), and the detailed inspection processing is done in the detailed inspecting mode (steps ST3, ST5).

<Simple Inspection Processing>

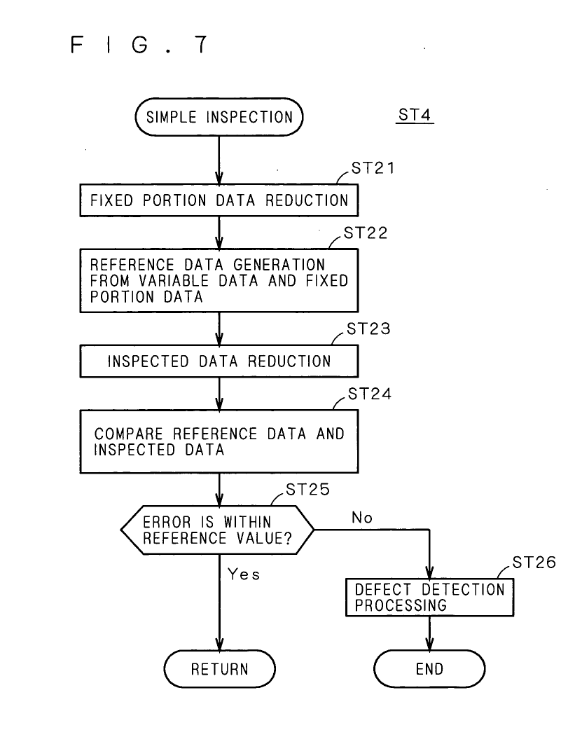

The simple inspection processing (FIG. 6, step ST4) will first be described. FIG. 7 is a diagram showing a detailed flow of the simple inspection processing.

A portion corresponding to a target unit region in the fixed portion data 72 stored in the fixed portion data memory 63 is first captured. Then, the pixels of the fixed portion data 72 related to this target unit region are reduced at a predetermined rate so as to lower its resolution by the fixed portion data reducing part 62 (step ST21).

The fixed portion data 72 related to the target unit region and the variable portion data 71 related to the target unit region inputted from the printing system 2 are synthesized to generate reference data 73 related to the target unit region by the reference data generating part 61 (step ST22).

This reference data 73 is image data used for comparison with the inspected data 74. Since the inspected data 74 can be obtained from the actually printed printing paper 82, it contains both of a fixed portion and a variable portion. Therefore it is also necessary for the reference data to contain the contents of both of the fixed portion and the variable portion. For this reason, the reference data 73 is to be generated by synthesizing the variable portion data 71 and the fixed portion data 72.

Additionally, the resolution of the variable portion data 71 that has been used for generating the reference data 73 is previously reduced in the printing system 2. The resolution of the fixed portion data 72 is already reduced by the fixed portion data reducing part 62. This permits generation of the reference data 73 having a relatively low resolution.

Next, as in step ST21, the pixels of the inspected data 74 related to the target unit region obtained by the image pickup sensor 32 are reduced at a predetermined rate so as to lower its resolution by the inspected data reducing part 65 (step ST23).

Then, the inspected data 74 related to the target unit region and the reference data 73 related to the target unit region generated by the reference data generating part 61 are compared to obtain an error between the pixels at the same position (step ST24). Subsequently it is determined whether the obtained error is within a reference value or not (step ST25). This reference value is previously set in the data comparison part 64.

When the error found by comparison is within the reference value (“YES” in step ST25), it is determined that the printing state at the target unit region of the printing paper 8 is excellent. This determination result is then inputted to the control part 1, as inspection result data 75, and the print inspection processing is continued.

On the other hand, when the error found by comparison exceeds the reference value (“NO” in step ST25), it is determined that the printing state at the target unit region of the printing paper 8 is poor, and this determination result is then inputted to the control part 1 as inspection result data 75. Subsequently, a predetermined defect detection processing to be executed upon detecting a defective printing is performed under the control of the control part 1 (step ST26). In this preferred embodiment, the operation of the printing apparatus 10 is entirely stopped as a defect detection processing. Alternatively, the print inspection processing may be resumed after a mark such as a label is attached to a target unit region determined poor, as the defect detection processing.

<Detailed Inspection Processing>

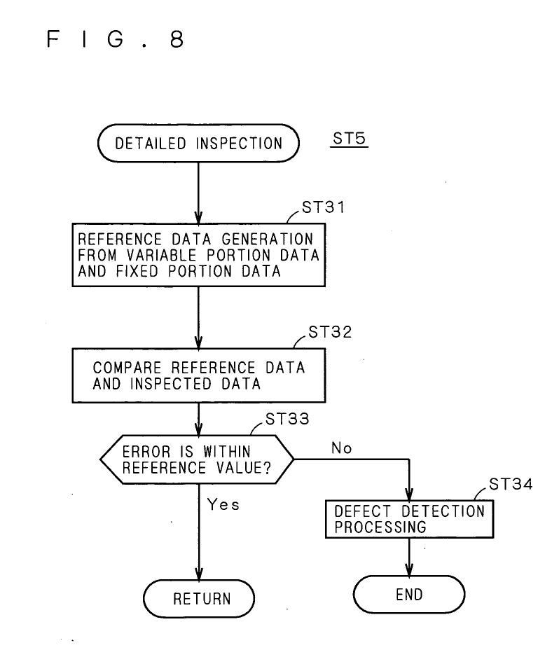

The detailed inspection processing (FIG. 6, step ST5) will next be described. FIG. 8 is a diagram showing a detailed flow of the detailed inspection processing.

First, a portion corresponding to a target unit region in the fixed portion data 72 stored in the fixed portion data memory 63, and the variable portion data 71 related to the target unit region inputted from the printing system 2 are directly synthesized by the reference data generating part 61, thereby generating reference data 73 related to the target unit region (step ST31).

The variable portion data 71 and the fixed portion data 72 that have been used for generating this reference data 73 are not reduced in resolution. It is therefore possible to generate the reference data 73 that uses all of the pixels of the variable portion data 71 and the fixed portion data 72, and that has a relatively high resolution.

Next, the reference data 73 related to the target unit region and the inspected data 74 related to the target unit region obtained by the image pickup sensor 32 are directly compared to obtain an error between the pixels at the same position (step ST32). Since the resolution of the inspected data 74 is not reduced before this comparison, the inspected data 74 having a relatively high resolution can be used for comparison. Thereafter, as in the simple inspection processing, it is determined whether the error found by comparison is within a reference value or not, and the processing according to the determination is performed (steps ST33, ST34).

<Summary of Inspection Processing>

As above described, in the simple inspecting mode, the resolution of all of the image data used for inspection (the variable portion data 71, fixed portion data 72, and inspected data 74) is lowered to reduce the amount of data. On the other hand, in the detailed inspecting mode, all of the pixels of the entire image data used for inspection are utilized to maintain the amount of data. For this reason, in the simple inspecting mode, the reference data 73 and the inspected data 74, both of which are low in resolution, are compared to make the simple inspection in which the amount of data compared per unit region is relatively small. On the other hand, in the detailed inspecting mode, the reference data 73 and the inspected data 74, both of which are high in resolution, are compared to make the detailed inspection in which the amount of data compared per unit region is relatively large. The simple inspection is low in the accuracy of inspection, but it is possible to considerably reduce the amount of data handled during inspection. In contrast, the detailed inspection permits high accuracy of inspection.

Returning to FIG. 6, the above-mentioned sequence of processing of the inspection system 3 will be repeated per unit region of the printing paper 8, until the completion of the inspection for all of the regions of the printing paper 8 (during “NO” in step ST6).

Through this processing, the region that is taken as a target unit region of the printing paper 8 in the detailed inspecting mode is used as an object of inspection in the detailed inspection, and the region that is taken as a target unit region in the simple inspecting mode is used as an object of inspection in the simple inspection. Accordingly the entire region of the printing paper 8 can be classified as an object of inspection in either the detailed inspection or the simple inspection, so that all of the regions of the printing paper 8 are subjected to inspection in the printing apparatus 10. In other words, some regions of the printing paper 8 are taken as an object of inspection in the detailed inspection, and the rest is taken as an object of inspection in the simple inspection.

Provided that the entire region of the printing paper 8 is the object of inspection in the detailed inspection, it is not impossible to make high accuracy of inspection for the entire region, however, it is necessary to handle an enormous amount of data during inspection. This can cause the problem of lowing the accuracy of inspection, thus leading to a drop in printing speed. In contrast, provided that the entire region of the printing paper 8 is the object of inspection in the simple inspection, because the amount of data handled can be reduced, neither the accuracy of inspection nor printing speed can be lowered, but it is impossible to detect a defect of low level (such a defect as to be detectable only by the detailed inspection). In both cases, the technical demand of “maintaining the accuracy of inspection” and the technical demand of “reducing the amount of data” are incompatible and conflict with each other.

On the other hand, as in this preferred embodiment, if only a partial region of the printing paper 8 is used as an object of inspection in the detailed inspection, any low level defects can be found during the detailed inspection, while significantly reducing the amount of data handed in the inspection. Thereby, the two conflicting technical demands of “maintaining the accuracy of inspection” and “reducing the amount of data” are compatible while striking a balance between the two. There is the possibility of failing to detect a low level defect in the region taken as an object of the simple inspection. In general, it is rare for the generated defect to repair naturally in a printing apparatus. Therefore, for example, a periodical detailed inspection for a predetermined event enables easy post-specification of the locations of defects because, when a low level defect is detected in a certain detailed inspection, the location of a defect in the printing paper 8 can be specified somewhere between the region taken as an object of the previous detailed inspection and that of the current detailed inspection.

<1-7. Region Taken as Object of Detailed Inspection>

The region of the printing paper 8 that is taken as an object of inspection in the detailed inspection will next be described. As discussed above, the switching of the inspecting mode is done depending on the mode signal MS. Hence, the mode signal MS determines which region of the printing paper 8 will be taken as an object of inspection in the detailed inspection.

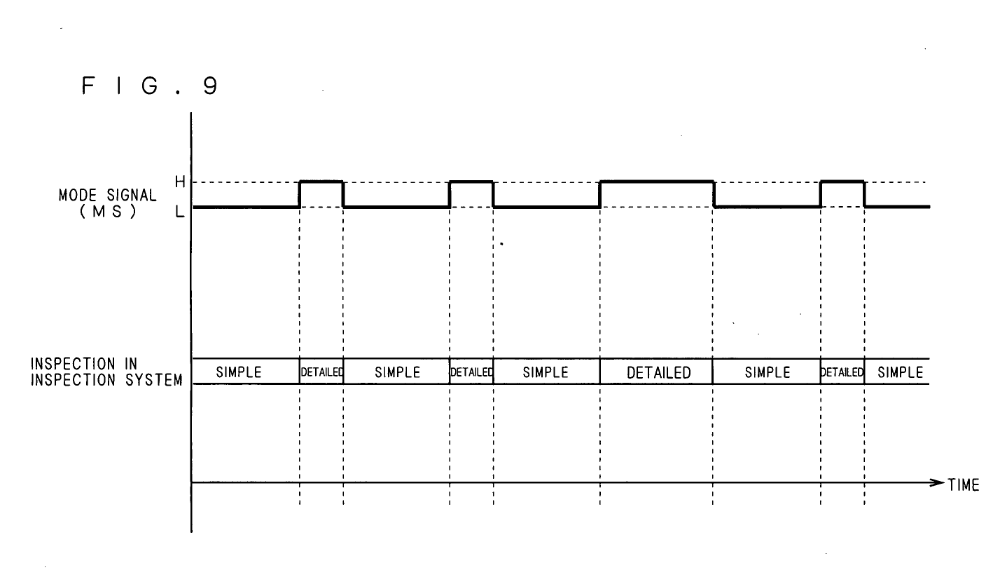

FIG. 9 is a time chart showing the relationship between the mode signal MS and the inspection made by the inspection system 3. The mode signal MS is a signal that has either value of “H” or “L”, wherein “H” corresponds to the detailed inspecting mode, and “L” corresponds to the simple inspecting mode.

Referring to FIG. 9, when the mode signal MS becomes “H”, the detailed inspection is made in the inspection system 3. In other cases the simple inspection is made. Accordingly, the length of a region subjected to the detailed inspection can be changed depending on the length of the period of time that the mode signal MS is “H”. In other words, the mode signal MS determines as to which position and which length of region in the printing paper 8 will be subjected to the detailed inspection.

The followings are three specific examples of regions of the printing paper 8 that become an object of inspection in the detailed inspection. The printing apparatus 10 may employ any one of these.

### FIRST EXAMPLE

### Per Group

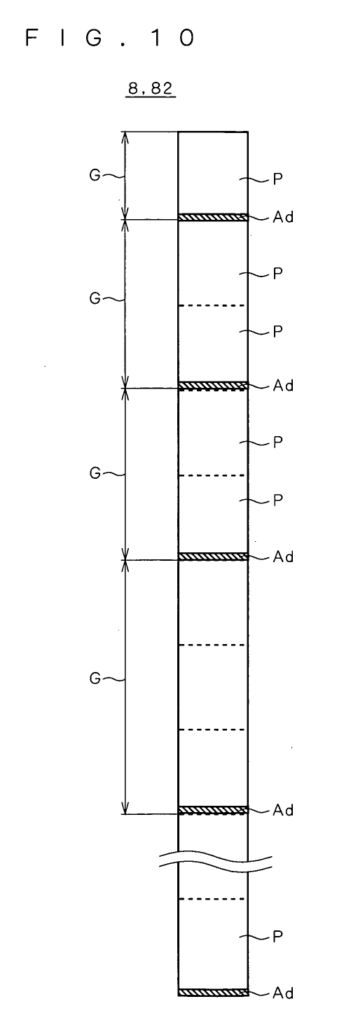

A first example of regions to be an object of inspection in the detailed inspection will now be described. FIG. 10 is a diagram showing the first example. Provided that the upper side of this figure is an advance side in printing (the side that is positioned higher in the printing sequence).

Referring to FIG. 10, in the first example, a back end region to be printed finally in each of a plurality of groups G contained in the printing paper 8 is used as an object of inspection Ad in the detailed inspection. In other words, one region for one group G is set as an object of inspection Ad in the detailed inspection. This provides the detailed inspection per group G, thereby enabling to check per group whether the print is excellent or not. It is therefore easy to manage the printing paper 8 per group.

Although in this example, only one region is set with respect to one group G as an object of inspection Ad in the detailed inspection, a plurality of regions may be set. In other words, at least one region for one group G may be set as an object of inspection Ad in the detailed inspection. Moreover, the region to be an object of inspection Ad in the detailed inspection is not limited to the back end region in the group G, it may be other regions such as a top region that is subjected to the most advanced printing in the group G, or a middle region, at which predetermined information is printed, between the top region and the back end region.

### SECOND EXAMPLE

### Per Paper Block

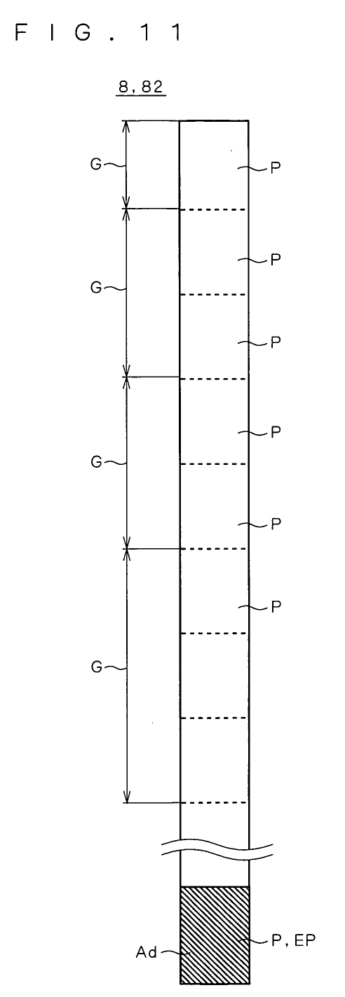

A second example of regions taken as an object of inspection in the detailed inspection will next be described. FIG. 11 is a diagram showing the second example. The upper side of this figure is also taken to be an advance side in printing.

Referring to FIG. 11, in the second example, the entire region of an end page EP, whose printing sequence is the final in a plurality of pages P contained in a paper block (paper roll) as a whole of the printing paper 8, is taken as an object of inspection Ad in the detailed inspection. Such setting of the region to be an object of inspection Ad in the detailed inspection is done similarly with respect to all paper blocks handled by the printing apparatus 10. Specifically, one region for one paper block is set as an object of inspection Ad in the detailed inspection. This provides the detailed inspection per paper block, thereby enabling to check in paper block unit whether the print is excellent or not. It is therefore easy to manage the printing paper 8 per paper block.

Although in this example, only one region for one paper block is set as an object of inspection Ad in the detailed inspection, a plurality of regions may be set. In other words, at least one region for one paper block may be set as an object of inspection Ad in the detailed inspection. Moreover, the size of the region to be an object of inspection Ad in the detailed inspection may not be the entire region of one page, or it may be a partial region of one page.

Further, the region to be an object of inspection Ad in the detailed inspection is not limited to the end page EP, and it may be other page. However, when one region of the end page EP or a visible page close to the end page EP is set as an object of inspection Ad in the detailed inspection, as shown in the example of FIG. 11, it is easy to make visual check of the region set as an object of inspection in the detailed inspection in the printing paper 82 at the completion of printing.

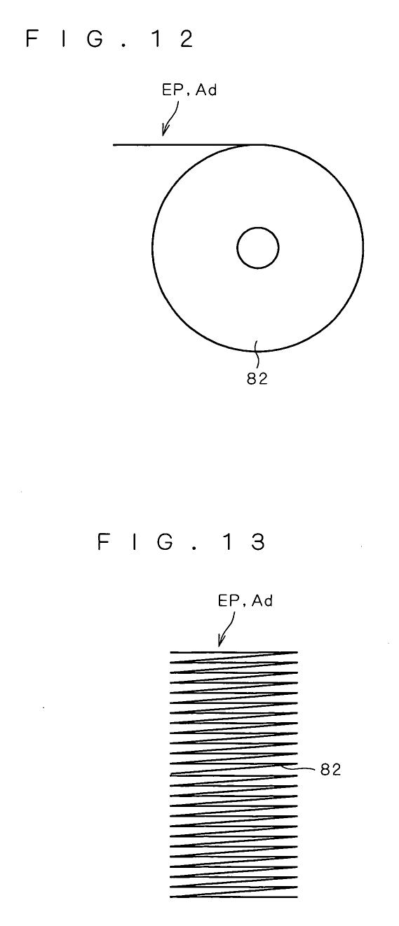

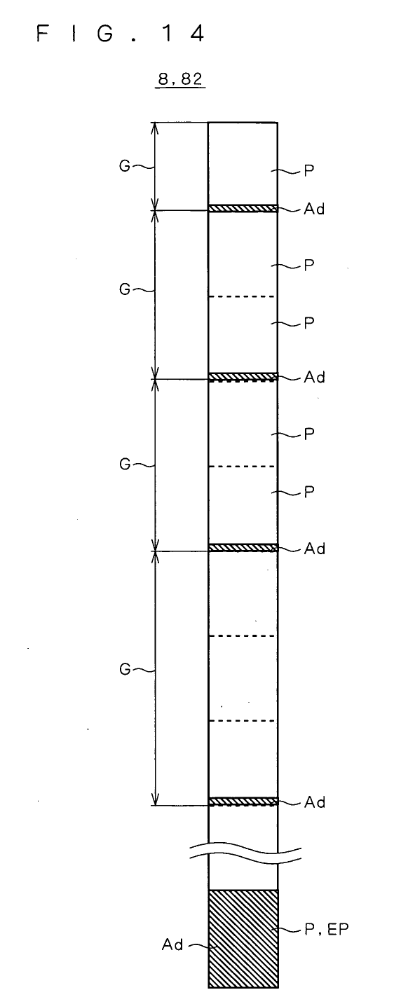

The after-print printing paper 82 is then removed from the printing apparatus 10, as a paper block wound in a roll shape as shown in FIG. 12. At this time, the end page EP (a visible page close to the end page EP) is located at the outermost periphery of the roll-shape paper block, so that its content can be visually checked with ease. Accordingly, the result of the detailed inspection in the inspection system 3 and the result of the visual check can be easily compared. For example, if the result of the detailed inspection is a printing defect, it is easy to make visual check whether such a printing defect is actually present or not at the region detected as being the printing defect.

Although in the printing apparatus 10 of this preferred embodiment, the paper block as a whole of the after-print printing paper 82 is formed in a roll shape, the paper block may be, for example, in the shape of a rectangular solid in which a plurality of pages contained therein are incorporated in the shape of bellows. In this case, the end page EP is located at the uppermost part of the paper block of rectangular solid shape. Therefore, even in such a case, if one region contained in the end page EP is taken as an object of inspection Ad in the detailed inspection, it is similarly easy to make visual check of the region taken as an object of inspection Ad in the detailed inspection.

### THIRD EXAMPLE

### Combination

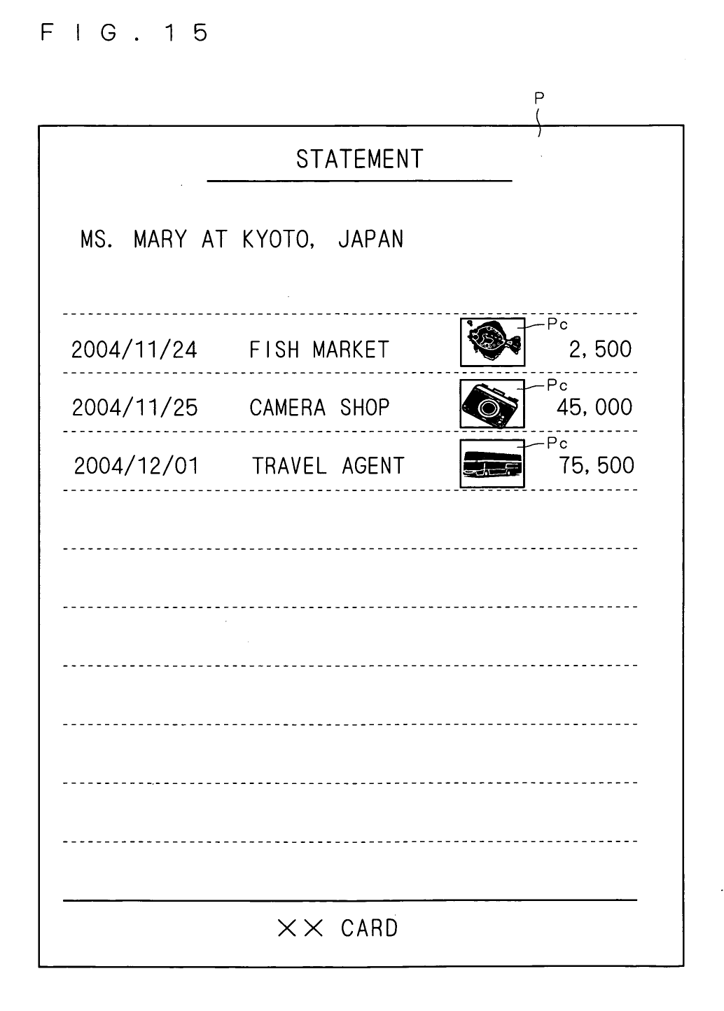

Alternatively, a region obtained by combining the first and second examples may be taken as an object of inspection Ad in the detailed inspection. FIG. 14 is a diagram showing a third example in such a case. Referring to FIG. 14, in the third example, one region for one group G of the printing paper 8 is taken as an object of inspection Ad in the detailed inspection, and further the entire region of an end page EP in a plurality of pages P contained in a paper block is taken as an object of inspection Ad in the detailed inspection. This enables to check whether print is excellent or not both in group and in paper block, thereby further facilitating the management of the printing paper 8.

<1-8. Summary of First Preferred Embodiment>

As described in the first preferred embodiment, the inspection system 3 of the printing apparatus 10 can provide the detailed inspection in which the amount of data taken as an object of comparison in the printing paper 8 is relatively large, and the simple inspection in which the amount of the data is relatively small. A partial region of the printing paper 8 is taken as an object of inspection in the detailed inspection, and the rest is taken as an object of inspection in the simple inspection. Hence, the amount of data handled in the inspection can be considerably reduced without any large drop in the accuracy of inspection.

The printing apparatus 10 also provides variable printing, so that a plurality of pages contained in the after-print printing paper 82 have different contents. It is therefore preferable to inspect the entire printing paper 8. Even in the inspection for the entire printing paper 8, the printing apparatus 10 permits substantial reductions in the amount of data handled in the inspection.

Further, the fixed portion data 72 indicating the fixed portion except for the variable portion is already stored in the fixed portion data memory 63 prior to inspection. The reference data 73 is generated on the basis of the fixed portion data 72 and the variable portion data 71 inputted from the printing system 2 to the print inspection part 31. Therefore, when generating the reference data 73, only the variable portion data 71 may be inputted from the printing system 2, thereby reducing the amount of data to be inputted.

In the detailed inspecting mode, the variable portion data 71 of all pixels is inputted from the printing system 2. In the simple inspecting mode, the variable portion data 71, the resolution of which has been lowered, is inputted from the printing system 2. Specifically, the amount of data of the variable portion data 71 inputted from the printing system 2 to the print inspection part 31 is sufficient for the detailed inspection when the variable portion data 71 is used in the detailed inspection, whereas it is insufficient for the detailed inspection but sufficient for the simple inspection when the variable portion data 71 is used in the simple inspection. Thus, since only the amount of data necessary for inspection is inputted as the variable portion data 71, the amount of data inputted for generating the reference data 73 can be further reduced.

### <2. Second Preferred Embodiment>

<2-1. Outline>

A second preferred embodiment of the invention will next be described. The main structure of a printing apparatus 10 of this preferred embodiment is the same as that shown in FIG. 1. Note that in this preferred embodiment a reuse portion is contained in a variable portion.

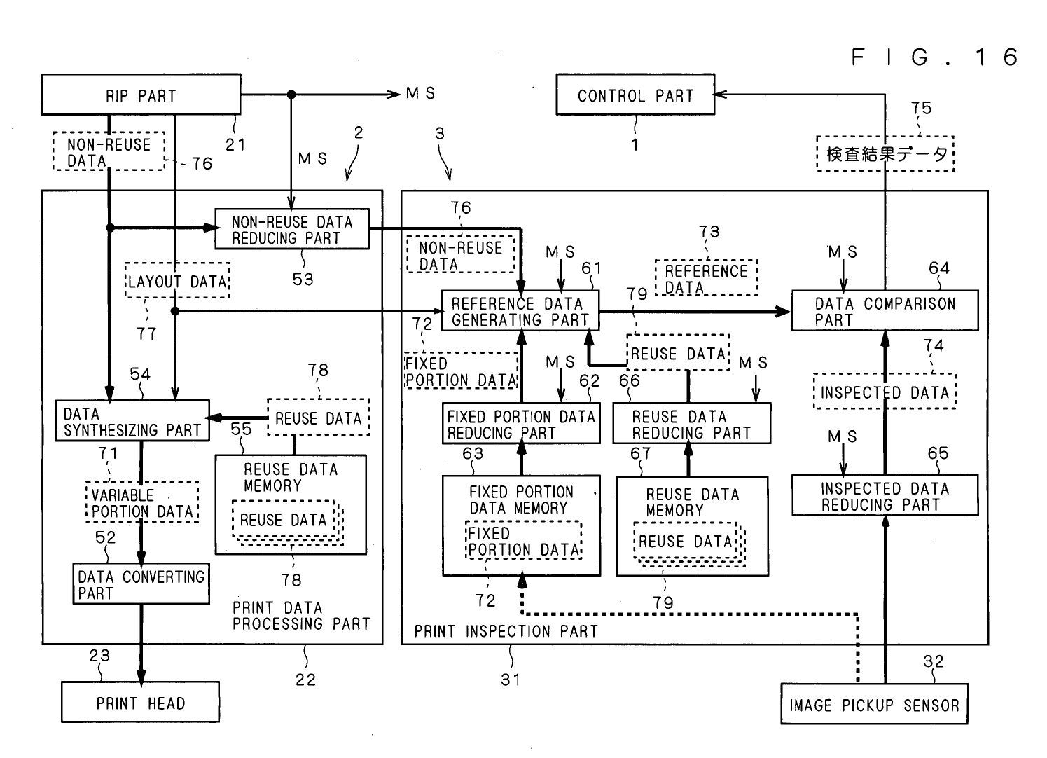

FIG. 15 is a diagram showing an example of the contents of one page P of printing paper 82 to which printing has been performed by the printing apparatus 10 in this preferred embodiment. The form of before-print printing paper 81 in this preferred embodiment is the same as that shown in FIG. 2. A comparison of FIG. 2 with FIG. 15 indicates that a reuse portion Pc, such as gradation data, is contained in part of a variable portion to be printed by the printing apparatus 10.

Reuse data used for printing the reuse portion Pc often contains gradation data as shown in FIG. 15, and the amount of data is extremely larger than the reuse data used for printing a non-reuse portion except for the reuse portion Pc (such as characters, symbols, and graphics). Therefore a print data processing part 22 in this preferred embodiment previously stores a plurality of reuse data that become candidates for printing the reuse portion Pc. In printing the reuse portion Pc in a variable portion, instead of inputting the reuse data itself, the stored reuse data is used. Likewise, a print inspection part 31 previously stores a plurality of reuse data, such that the stored reuse data is used at the time of generating reference data. In other words, each of the plurality of reuse data previously stored will be repeatedly used (reused).

The outline of the operation of the printing apparatus 10 in the second preferred embodiment is the same as that shown in FIG. 4. Specifically, like the first preferred embodiment, print processing (step S12) and inspection processing (step S22) are performed in parallel, as print inspection processing Ps1. Prior to the print inspection processing Ps1, a fixed portion data 72 is captured (step S21).

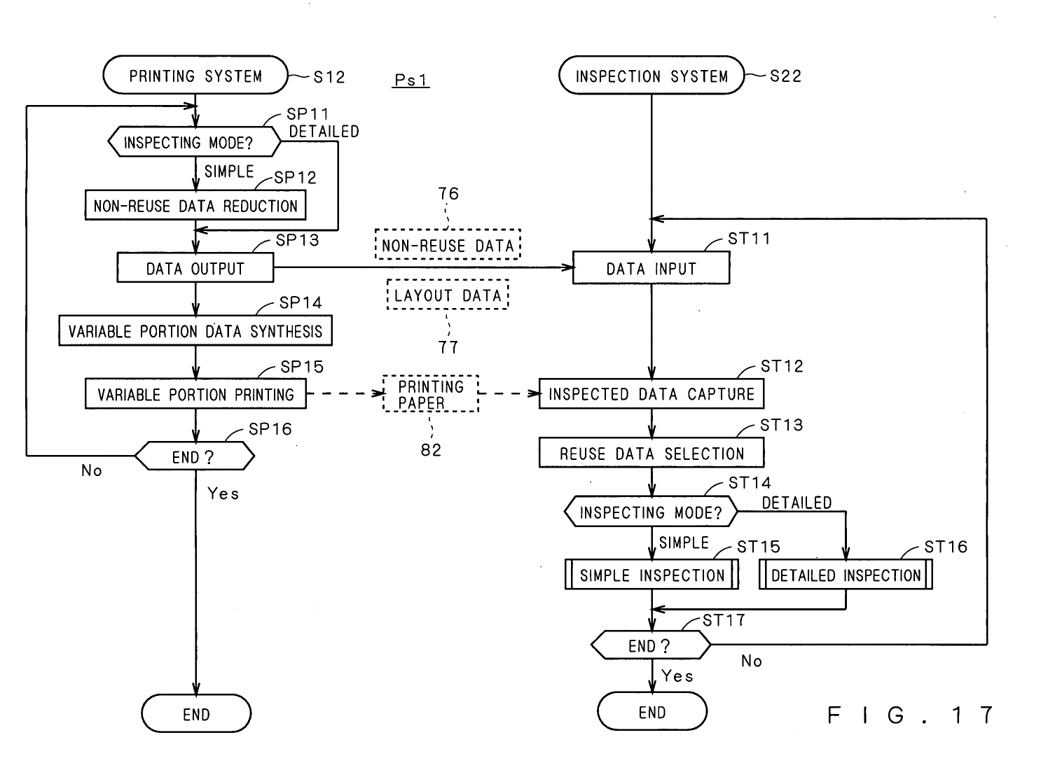

FIG. 16 is a block diagram showing the details of functions of a printing system 2 and an inspection system 3 that are related to the print inspection processing Ps1 in the second preferred embodiment.

A comparison of FIG. 5 with FIG. 16 indicates that a print data processing part 22 of this preferred embodiment has a data converting part 52 as in the first preferred embodiment, and a non-reuse data reducing part 53 in place of the variable portion data reducing part 51 in the first preferred embodiment. The print data processing part 22 is also provided with a data synthesizing part 54 as an image processing function, and a reuse data memory 55 that is an image memory. The reuse data memory 55 stores a plurality of reuse data 78 that become candidates for use in printing a reuse portion.

Like the first preferred embodiment, the print inspection part 31 of the second preferred embodiment has a reference data generating part 61, fixed portion data reducing part 62, fixed portion data memory 63, data comparison part 64, and inspected data reducing part 65. In addition, it has a reuse data reducing part 66 as an image processing function, and a reuse data memory 67 that is an image memory. Also in the second preferred embodiment, a mode signal MS is inputted from a RIP part 21 to each part as an image processing function, so as to perform image processing according to inspecting mode.

Like the reuse data memory 55 of the printing system 2, the reuse data memory 67 stores a plurality of reuse data 79, which are exactly the same (the same contents, and the same amount of data) as the plurality of reuse data 78 stored in the reuse data memory 55 of the printing system 2. The plurality of reuse data 78 and the plurality of reuse data 79 are previously stored prior to the print inspection processing Ps1.

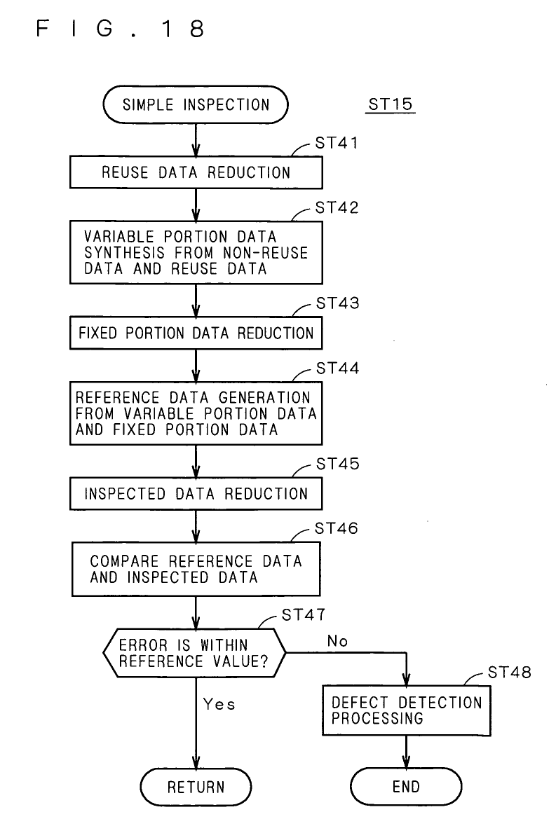

FIG. 17 is a diagram showing the details of processing of the printing system 2 and the inspection system 3 in the print inspection processing Ps1 of the second preferred embodiment. The flow on the left side in the figure indicates the flow of print processing in the printing system 2 (FIG. 4, step S12), and the flow on the right side indicates the flow of inspection processing in the inspection system 3 (FIG. 4, step S22). These details will be described sequentially.

<2-2. Print Processing>

Referring now to the left side flows in FIGS. 16 and 17, the print processing of the printing system 2 in the second preferred embodiment will be discussed.

Also in the second preferred embodiment, until the completion of the printing of all pages contained in printing paper 8 (during “NO” in step SP16), the printing of variable portions is performed per unit region of the printing paper 8 (step SP15). In this preferred embodiment, the data synthesizing part 54 synthesizes reuse data 78 and non-reuse data 76 to generate variable portion data 71 (step SP14).

As to the reuse data 78 and the non-reuse data 76 that are the origins of the variable portion data 71, only the non-reuse data 76 is inputted from a RIP part 21. As the reuse data 78, previously stored one in the reuse data memory 55 is used. A plurality of reuse data 78 is stored in the reuse data memory 55. Which of these will be used for printing is designated by layout data 77 to be inputted together with the non-reuse data 76 from the RIP part 21.

The layout data 77 is designating information that designates one used for printing from the plurality of reuse data 78 in the reuse data memory 55, and designates which layout is to be employed in synthesizing the designated reuse data 78 and the non-reuse data 76. Accordingly, the layout data 77 has an extremely smaller amount of data than image data.

In printing one unit region, first, non-reuse data 76 related to this unit region, and layout data 77 are inputted from the RIP part 21. Then, reference is made to the layout data 77, and the data synthesizing part 54 selects reuse data 78 to be used for printing from the reuse data memory 55. Portions related to the unit region to be printed in the selected reuse data 78, and the non-reuse data 76 are synthesized to generate variable portion data 71 (step SP14).

The generated variable portion data 71 is then converted to head data and supplied to a print head 23 by a data converting part 52. Upon this, the print head 23 performs printing related to this unit region of the variable portion containing a reuse portion, to the printing paper 8 (step SP15).

Prior to the printing relating to such one unit region, the followings are performed in the same manner as in the processing related to the variable portion data 71 in the first preferred embodiment. Specifically, the non-reuse data 76 related to one unit region that is used for this printing is adjusted in resolution according to the inspecting mode by the non-reuse data reducing part 53 (steps SP11, SP12), and then outputted from the print data processing part 22 to the print inspection part 31 (step SP13).

In the second preferred embodiment, together with the above non-reuse data 76, the layout data 77 inputted from the RIP part 21 is also outputted from the print data processing part 22 to the print inspection part 31 (step SP13).

Thus, the printing system 2 repeats per unit region a sequence of processing of: the adjustment of resolution of the non-reuse data 76 according to the inspecting mode (steps SP11, SP12); the output of the non-reuse data 76 and the layout data 77 to the print inspection part 31 (step SP13); the synthesis of the variable portion data 71 (step SP14); and the printing based on the variable portion data 71 (step SP15).

<2-3. Inspection Processing>

The inspection processing in the inspection system 3 to be done in parallel with the above processing in the printing system 2 will be described with reference to the right side flows in FIGS. 16 and 17.

Like the first preferred embodiment, the inspection system 3 of the second preferred embodiment repeats inspection for one unit region related to the non-reuse data 76 inputted from the printing system 2, until the completion of the inspection for all regions of the printing paper 8 (during “NO” in step ST17). Hereinafter, a unit region that becomes an object of inspection at that point is referred to as a “target unit region.”

In inspecting, first, both of two data outputted from the printing system 2 (the non-reuse data 76 related to a target unit region, and the layout data 77) are inputted to a reference data generating part 61 (step ST11). An image pickup sensor 32 scans the target unit region on the printing paper 82, and optical system strain is corrected to obtain inspected data 74 related to the target unit region (step ST12). Reference is made to the layout data 77, and reuse data 79 having the same content as the reuse data 78 used in printing is selected from the reuse data memory 67 by the reference data generating part 61. Only a portion related to the target unit region in the selected reuse data 79 is captured (step ST13).

This is followed by processing according to the inspecting mode based on a mode signal MS. Specifically, when the inspecting mode is the simple inspecting mode, simple inspection processing (steps ST14, ST15) is done. When it is the detailed inspecting mode, detailed inspection processing (steps ST14, ST16) is done. Also in the second preferred embodiment, a comparison of data after lowering its resolution is made in the simple inspection processing. On the other hand, a comparison of data without lowering its resolution is made in the detailed inspection processing.

<Simple Inspection Processing>

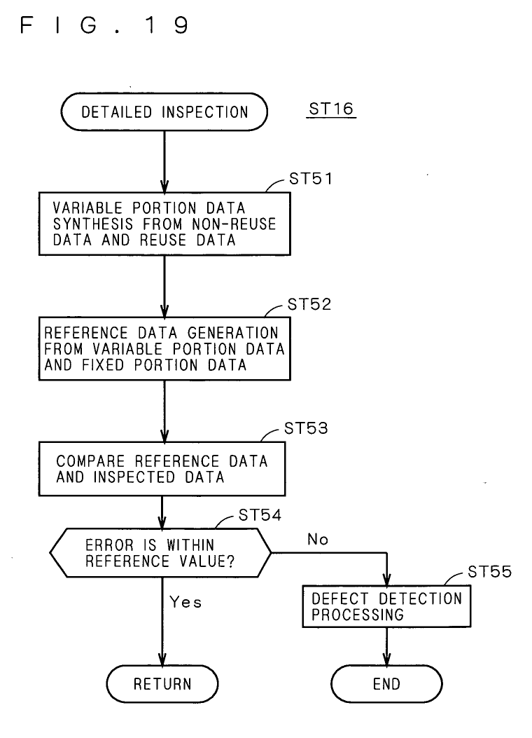

Simple inspection processing (FIG. 17, step ST15) will now be described. FIG. 18 is a diagram showing a detailed flow of simple inspection processing.

First, the reuse data reducing part 66 reduces the pixels of reuse data 79 related to a target unit region at a predetermined rate so as to lower its resolution (step ST41).

Based on layout data 77, the reuse data 79 related to this target unit region and non-reuse data 76 related to the target unit region inputted from the printing system 2 are synthesized to generate variable portion data related to the target unit region by the reference data generating part 61 (step ST42). The variable portion data so generated has the same contents as the variable portion data 71 used for printing in the printing system 2.

A portion corresponding to the target unit region is obtained from the fixed portion data 72 stored in the fixed portion data memory 63. The fixed portion data reducing part 62 reduces the pixels of the fixed portion data 72 related to the target unit region at a predetermined rate so as to lower its resolution (step ST43).

Then, the fixed portion data 72 related to the target unit region, and the variable portion data related to the target unit region that has been generated in step ST42 are synthesized to generate reference data 73 related to the target unit region by the reference data generating part 61 (step ST44).

The reuse data 79, the non-reuse data 76, and the fixed portion data 72, which have been used for generating the reference data 73, are respectively lowered in resolution. This results in the reference data 73 having a relatively low resolution.

The pixels of the inspected data 74 related to the target unit region captured by the image pickup sensor 32 is reduced at a predetermined rate, as in step ST41, such that its resolution is lowered by the inspected data reducing part 65 (step ST45).

Next, the inspected data 74 related to the target unit region is compared with the reference data 73 related to the target unit region that has been generated by the reference data generating part 61, in order to obtain an error between the pixels at the same position (step ST46). Thereafter, like the first preferred embodiment, it is determined whether the error found by comparison is within a reference value or not, and processing according to the determination is performed (steps ST47, ST48).

<Detailed Inspection Processing>

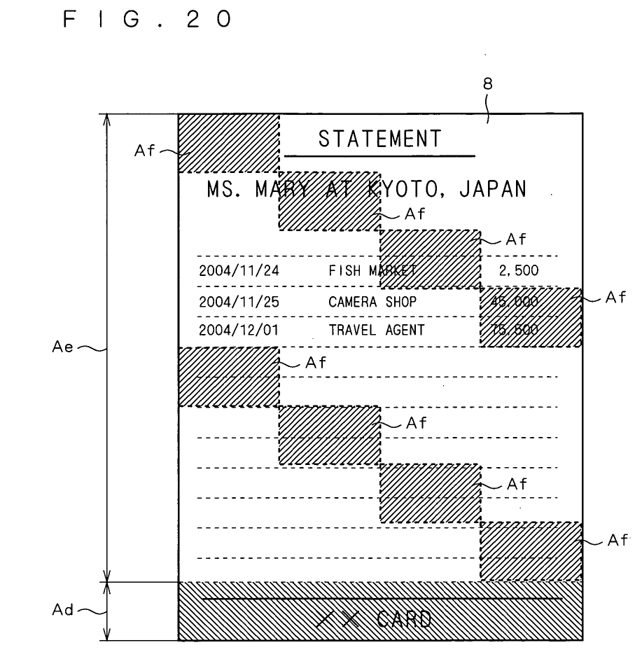

Detailed inspection processing (FIG. 17, step ST16) will next be described. FIG. 19 is a diagram showing a detailed flow of the detailed inspection processing.

Based on the layout data 77, the reference data generating part 61 performs a direct synthesis of the reuse data 79 related to the target unit region, and the non-reuse data 76 related to the target unit region that has been inputted from the printing system 2, thereby generating variable portion data related to the target unit region (step ST51).

Next, the reference data generating part 61 performs a direct synthesis of the variable portion data so generated, and the portion of the fixed portion data 72 stored in the fixed portion data memory 63, which corresponds to the target unit region, thereby generating reference data 73 related to the target unit region (step ST52).

The reuse data 79, the non-reuse data 76, and the fixed portion data 72, which have been used for generating the reference data 73, are not lowered in resolution. This results in the reference data 73 having a relatively high resolution.

A direct comparison between the reference data 73 related to the target unit region and the inspected data 74 related to the target unit region, which has been captured by the image pickup sensor 32, is made to obtain an error between the pixels at the same position (step ST53). Thereafter, like the first preferred embodiment, it is determined whether the error obtained by comparison is within a reference value or not, and processing according to the determination is performed (steps ST54, ST55).

<2-4. Summary of Second Preferred Embodiment>

Thus, also in the second preferred embodiment, the respective resolutions of all image data used for inspection (the non-reuse data 76, reuse data 79, fixed portion data 72 and inspected data 74) are lowered to reduce the amount of data in the simple inspecting mode. On the other hand, all pixels of all image data used for inspection are utilized to maintain the amount of data in the detailed inspecting mode. Therefore, the simple inspecting mode is to perform the simple inspection in which the amount of data compared per unit region is relatively small, and the detailed inspecting mode is to perform the detailed inspection in which the amount of data compared per unit region is relatively large. Hence, like the first preferred embodiment, if the object region of the detailed inspection is set by the mode signal MS, the two conflicting technical demands of “maintaining accuracy of inspection” and “reducing the amount of data” are compatible while striking a balance between the two, as in the case with the first preferred embodiment.

Additionally in the second preferred embodiment, the plurality of reuse data 79 having the same contents as the plurality of reuse data 78, which become candidates that the printing system 2 uses in printing reuse portions, are being stored in the reuse data memory 67 of the print inspection part 31 prior to inspection. The reference data 73 is generated on the basis of the reuse data 79 designated by the layout data 77 from among the plurality of reuse data 79, and the non-reuse data 76 inputted from the printing system 2, and the fixed portion data 72 stored in the fixed portion data memory 63. Consequently, even when a variable portion contains a reuse portion related to a reuse image, there is no need to input reuse data having a huge amount of data from the printing system 2 in order to generate the reference data 73. This permits substantial reductions in the amount of data to be inputted.

While the second preferred embodiment describes that the plurality of reuse data 78 stored in the printing system 2, and the plurality of reuse data 79 stored in the inspection system 3 have the same contents and the same amount of data, the amount of data of the latter may be smaller than that of the former if the latter has the same contents as the former. For example, the amount of data stored in the reuse data memory 67 can be considerably reduced by setting each of the plurality of reuse data 79 in the inspection system 3, such that it is insufficient for the detailed inspection, but sufficient for the simple inspection.

### <3. Other Preferred Embodiments>

The followings are other preferred embodiments.

<3-1. Only Variable Portion>

Although the foregoing preferred embodiments describe that the contents of the after-print printing paper 82 contain a fixed portion and a variable portion, only the variable portion may be contained in the absence of fixed portion (pre-printing). In this case, the reference data 73 may be generated only from variable portion data. Further, since the fixed portion data 72 is unnecessary, neither the fixed portion data reducing part 62 nor the fixed portion data memory 63 is necessary.

With a printing apparatus complying with applications where the printing content has a fixed portion and where it has no fixed portion, whether or not to use fixed portion data may depend on whether or not the printing contents include a fixed portion.

<3-2. Fixing of Additional Printing>

While the foregoing preferred embodiments are concerned with additional variable printing of the content specific to each one of a plurality of pages with respect to the fixed portion contained in the before-print printing paper 81 (pre-printing), these may be concerned with additional printing of the content common to a plurality of pages.

In such a case, because the content to be printed additionally is fixed, once print data for this printing has been inputted to store in a predetermined image memory, there is no need to input print data per unit region from the printing system 2 to the print inspection part 31.

<3-3. Region Restriction>

In the foregoing preferred embodiments, the resolutions of all image data used for inspection are lowered to reduce the amount of data in the simple inspection. In another alternative, the amount of data may be reduced by restricting the regions of all image data used for inspection to a partial region.

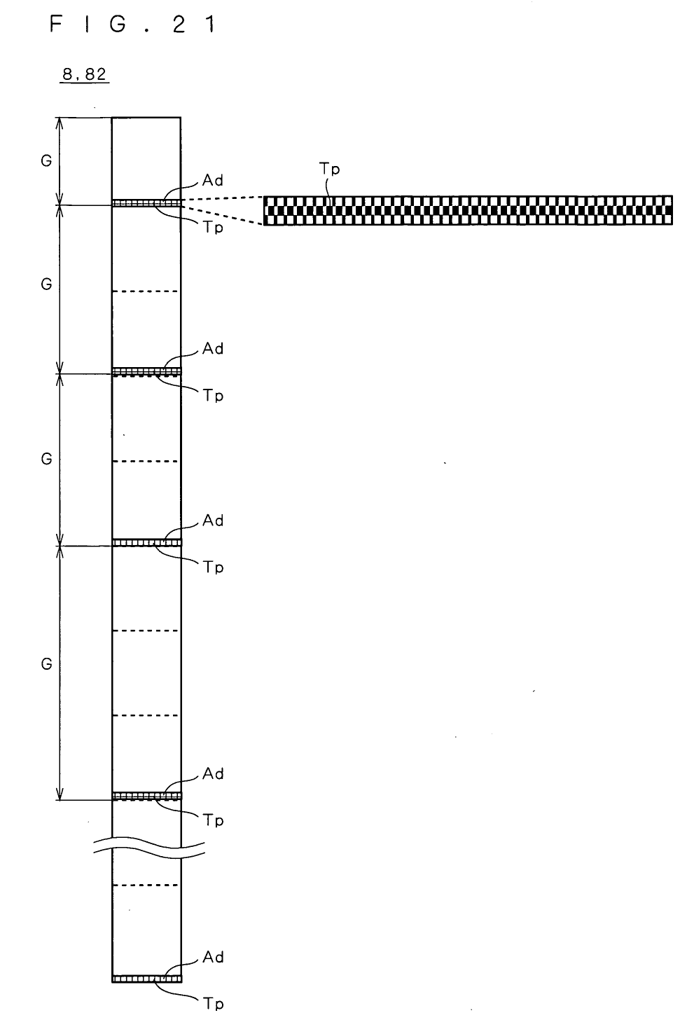

FIG. 20 is a diagram showing an example of regions that become objects of inspection in this case. The regions indicated by hatchings in FIG. 20 represent objects of inspection. In the regions of the printing paper 8 shown in this example, a lower end region is taken as an object of inspection Ad in the detailed inspection, and other regions as an object of inspection Ae in the simple inspection.

Referring to FIG. 20, the inspection to an object of inspection Ad in the detailed inspection covers all regions in the main scan direction (laterally in the figure). On the other hand, the inspection to an object of inspection Ae in the simple inspection is restricted to a partial region Af in the main scanning direction. In such a case, the position of the main scanning direction of the region Af for inspecting an object of inspection Ae in the simple inspection is preferably changed depending on the vertical scanning direction (temporarily), as indicated in FIG. 20. Also in this case, the resolutions of all image data used for the simple inspection may be reduced to further reduce the amount of data.

<3-4. Test Pattern>

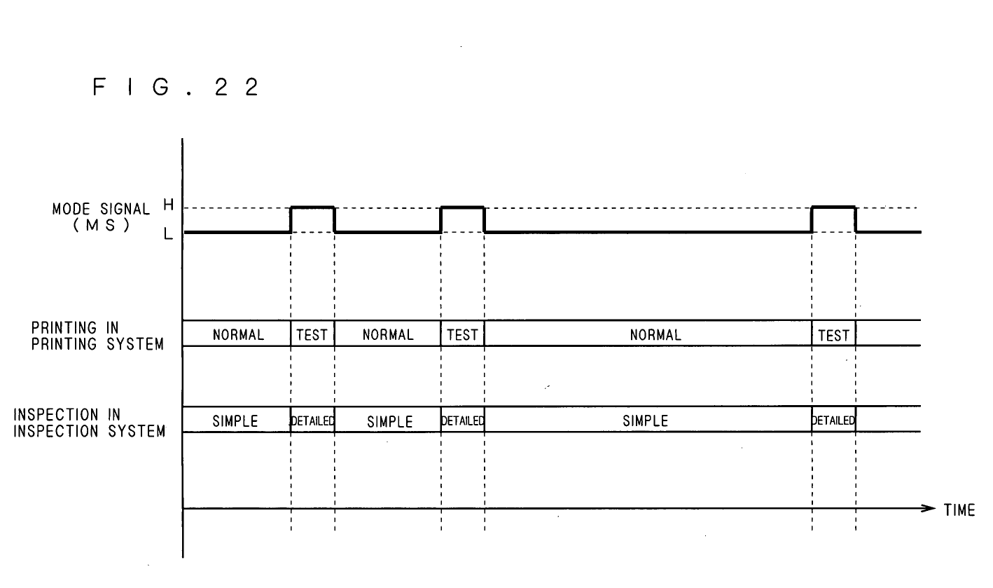

In another alternative, a predetermined test pattern may be printed on the printing paper 8 in order to employ this test pattern as an object of inspection in the detailed inspection. FIG. 21 is a diagram showing an example of regions that become objects of inspection in the detailed inspection. Also in this example, similarly to the example of FIG. 10, the rear end region of each group G is taken as an object of inspection Ad in the detailed inspection. Note that a test pattern Tp is already printed in each of the regions taken as objects of inspection in the detailed inspection.

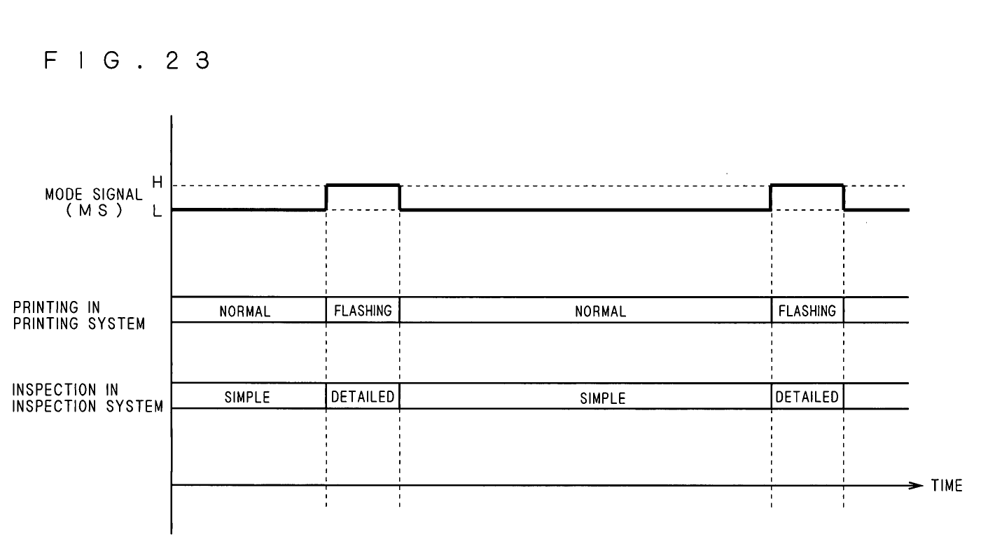

FIG. 22 is a time chart showing the relationship between the printing in the printing system 2 and the inspection in the inspection system 3. Since the time required for conveying the printing paper 8 is present between the printing for a certain unit region in the printing system 2, and the inspection for the same unit region in the inspection system 3, there is actually a time lag. However, to simplify the description, the printing and inspection related to the same unit region are indicated on the same time zone in FIG. 22.

Like FIG. 9, the inspection system 3 performs the detailed inspection when the mode signal MS is “H”, and the simple inspection in other cases. On the other hand, the printing system 2 performs printing of the predetermined pattern Tp when the mode signal MS is “H”, and the normal printing in other cases. This enables the predetermined pattern Tp to be printed on the printing paper 8, and the printed test pattern Tp to be taken as an object of inspection in the detailed inspection. Thus, taking the predetermined pattern Tp as an object of inspection permits substantial improvements in the accuracy of inspection in the detailed inspection.

<3-5. Maintenance Printing>

In another alternative, the result of maintenance printing conducted for maintaining the printing quality of the printing apparatus 10 may be used as an object of inspection in the detailed inspection. For example, to prevent clogging of nozzles contained in the print head 23 because the printing apparatus 10 in the foregoing preferred embodiments is an ink jet printer, it becomes necessary to perform a periodic flashing printing (maintenance printing) which forces ink out all nozzles in order to spray it to the printing paper 8. After this flashing printing, a flashing image is formed on the printing paper 8. In this case, the flashing image is taken as an object of inspection in the detailed inspection.

FIG. 23 is a time chart showing the relationship between the printing in the printing system 2 and the inspection in the inspection system 3. In FIG. 23, the printing and the inspection that are related to the same unit region are shown on the same time zone.

Like FIG. 9, the inspection system 3 performs the detailed inspection when a mode signal MS is “H”, and the simple inspection in other cases. On the other hand, the printing system 2 performs flashing printing when the mode signal MS is “H”, and the normal printing in other cases. This enables a flashing image to be used as an object of inspection in the detailed inspection.

The use of the maintenance printing result as an object of inspection in the detailed inspection makes it possible to perform at the same time the processing for maintaining the printing quality of the printing apparatus and the processing for inspecting the printing paper. It is therefore possible to considerably reduce the total time required for maintenance of the printing apparatus.

<3-6. Other Preferred Embodiments>

While the foregoing preferred embodiments are concerned with the case of applying the print inspection function to the printing apparatus 10 of ink jet type, the print inspection functions of the foregoing preferred embodiments may be applied to other printing apparatuses such as an offset printing apparatus and an electrophotographic printing apparatus. For example, since in the offset printing apparatus there is a region for maintenance printing called “side solid” in order to maintain the printing quality, this region may be taken as an object of inspection in the detailed inspection.

Although in the foregoing preferred embodiments, the input of the variable portion data 71, or the like to the print inspection part 31 is executed by the print data processing part 22 in the printing system 2, it may be done by the RIP part 21.

Moreover, when image data such as the variable portion data 71 is outputted from the printing system 2 to the print inspection part 31, the image data, prior to output, may be subjected to non-reciprocal compression. This permits further reductions in the amount of data that the print inspection part 31 should input in order to generate the reference data 73.

While the invention has been shown and described in detail, the foregoing description is in all aspects illustrative and not restrictive. It is therefore understood that numerous modifications and variations can be devised without departing from the scope of the invention.

What is claimed is:

1. A print inspection apparatus for inspecting printed material of a printing apparatus, comprising:
a reference generating part for generating reference data on the basis of print data that the printing apparatus uses for printing;
a capturing part for capturing inspected data from the printed material; and
an inspecting part for inspecting the printed material by comparing the reference data and the inspected data in unit region of the printed material,
wherein,
the inspecting part provides a detailed inspection in which an amount of data taken as an object of comparison in the unit region is relatively large, and a simple inspection in which the amount of the data is relatively small,
a partial region of the printed material is taken as an object of inspection in the detailed inspection, and
at least part of the region except for the partial region of the printed material is taken as an object of inspection in the simple inspection.

2. The print inspection apparatus according to claim 1 wherein
the printed material contains a plurality of pages, and
contents of the printed material include a variable portion specific to each of the plurality of pages.

3. The print inspection apparatus according to claim 2 further comprising:
a storing part for storing fixed portion data indicating a fixed portion except for the variable portion in the contents of the printed material,
wherein the reference regenerating part inputs variable portion data that the printing apparatus uses to print the variable portion, and generates the reference data on the basis of the variable portion data and the fixed portion data.

4. The print inspection apparatus according to claim 3 wherein
an amount of data of the variable portion data inputted to the reference generating part is sufficient for the detailed inspection when used in the detailed inspection, and is sufficient for the simple inspection but insufficient for the detailed inspection when used in the simple inspection.

5. The print inspection apparatus according to claim 2 further comprising:
a first storing part for storing a plurality of second reuse data having the same contents as a plurality of first reuse data that become candidates to be used by the printing apparatus when printing a reuse portion of the variable portion; and
a second storing part for storing fixed portion data indicating a fixed portion except for the variable portion in the contents of the printed material,
wherein the reference generating part inputs non-reuse data that the printing apparatus uses to print non-reuse portion except for the reuse portion in the variable portion, and designation information for designating first reuse data that the printing apparatus uses to print the reuse portion, and generates the reference data on the basis of second reuse data having the same contents as first reuse data designated by the designation information in the plurality of second reuse data, the non-reuse data, and the fixed portion data.

6. The print inspection apparatus according to claim 5 wherein
an amount of data of each of the plurality of second reuse data is insufficient for the detailed inspection and sufficient for the simple inspection.

7. The print inspection apparatus according to claim 1 wherein
the printed material is divided into a plurality of groups, each of which is composed of a continuous page group, and
at least one region in each of the groups is taken as an object of inspection in the detailed inspection.

8. The print inspection apparatus according to claim 1 wherein
the printed material is composed of a paper block containing a plurality of pages in a connected state, and
at least one region in the paper block is taken as an object of inspection in the detailed inspection.

9. The print inspection apparatus according to claim 8 wherein
at least one region of a visible page whose printing sequence is the final or near the final in the plurality of pages contained in the paper block is taken as an object of inspection in the detailed inspection.

10. The print inspection apparatus according to claim 1 wherein
a test pattern contained in the printed material is taken as an object of inspection in the detailed inspection.

11. The print inspection apparatus according to claim 1 wherein
a result of maintenance printing for maintaining printing quality of the printing apparatus contained in the printed material is taken as an object of inspection in the detailed inspection.

12. A printing apparatus capable of inspecting printed material, comprising:
a reference generating part for generating reference data on the basis of print data used for printing;
a capturing part for capturing inspected data from the printed material;
an inspecting part for inspecting the printed material by comparing the reference data and the inspected data in unit region of the printed material,
wherein,
the inspecting part provides a detailed inspection in which an amount of data taken as an object of inspection in the unit region is relatively large, and a simple inspection in which the amount of the data is relatively small,
a partial region of the printed material is taken as an object of inspection in the detailed inspection, and
at least part of a region except for the partial region of the printed material is taken as an object of inspection in the simple inspection.

13. The printing apparatus according to claim 12 wherein
the printed material contains a plurality of pages, and
contents of the printed material include a variable portion specific to each of the plurality of pages.

14. The printing apparatus according to claim 13 further comprising:
a storing part for storing fixed portion data indicating a fixed portion except for the variable portion in the contents of the printed material,
wherein the reference generating part generates the reference data on the basis of variable portion data used for printing the variable portion, and the fixed portion data.

15. A print inspection method for inspecting printed material of a printing apparatus, comprising the steps of:
(a) generating reference data on the basis of print data that the printing apparatus uses for printing;
(b) capturing inspected data from the printed material; and
(c) inspecting the printed material by comparing the reference data and the inspected data in unit region of the printed material,
wherein,
the step (c) provides a detailed inspection in which an amount of data taken as an object of inspection in the unit region is relatively large, and a simple inspection in which the amount of the data is relatively small,
a partial region of the printed material is taken as an object of inspection in the detailed inspection, and
at least part of a region except for the partial region of the printed material is taken as an object of inspection in the simple inspection.

16. The print inspection method according to claim 15 wherein
the printed material contains a plurality of pages, and
contents of the printed material include a variable portion specific to each of the plurality of pages.

17. The print inspection method according to claim 16 wherein
in the step (a), the reference data is generated on the basis of variable portion data that the printing apparatus uses to print the variable portion, and fixed portion data indicating a fixed portion except for the variable portion in the contents of the printed material.

18. The print inspection method according to claim 17 wherein
an amount of data of the variable portion data is sufficient for the detailed inspection when used in the detailed inspection, and is sufficient for the simple inspection but insufficient for the detailed inspection when used in the simple inspection.

19. The print inspection method according to claim 16 wherein
in the step (a), the reference data is generated on the basis of:
second reuse data having the same contents as one designated by predetermined designation information in a plurality of first reuse data that become candidates to be used by the printing apparatus when printing a reuse portion of the variable portion;
non-reuse data that the printing apparatus uses to print a non-reuse portion except for the reuse portion of the variable portion; and
fixed portion data indicating a fixed portion except for the variable portion in the contents of the printed material.

20. The print inspection method according to claim 19 wherein
an amount of data of the second reuse data is insufficient for the detailed inspection but sufficient for the simple inspection.
